(19) United States
(12) Patent Application Publication
(10) Pub. No.: US 2015/0353032 A1
(43) Pub. Date: Dec. 10, 2015

(54) DECORATIVE LICENSE PLATE FRAME AND CUSTOMIZED METHOD THEREOF

(71) Applicant: ACCVAL L.L.C., Dover, DE (US)

(72) Inventor: Chen-Jui LIAO, Taipei City (TW)

(21) Appl. No.: 14/759,763

(22) PCT Filed: Jan. 10, 2013
(86) PCT No.: PCT/US13/20926

§ 371 Date: Jul. 8, 2015

(51) Int. Cl. B60R 13/10; G09F 21/04; G06F 3/14; G09F 7/18

(52) U.S. Cl. CPC B60R 13/105; G09F 7/18; G09F 21/048; G06F 3/1446; G06F 3/1431

(57) ABSTRACT

An embodiment of the invention provides a decorative license plate frame and its customized method and system. The decorative license plate frame is fixed on a vehicle. The decorative license plate frame comprises a rectangular body, holding a license plate, and a first window, and a second window, wherein a first graphic card is connected to the first window and a second graphic card is connected to the second window, and the first graphic card and the second graphic card are detachable. In one embodiment, the first graphic card and the second graphic card are electronic cards with a display panel thereon for showing images which are transmitted from the vehicle owner or user.

### CROSS REFERENCE TO RELATED APPLICATIONS

The present invention is a National Stage Application of PCT Application Ser. No. PCT/US2013/020926, filed on Jan. 10, 2013. The PCT Application is hereby incorporated by reference in its entirety.

### BACKGROUND OF THE INVENTION

1. Field of the Invention

The present invention relates to a decorative license plate frame, and more particularly, to a customized decorative license plate frame and a manufacturing system thereof.

2. Description of the Related Art

Decorative license plate frames are popular among vehicle owners who personalize their license plates. Decorative license plate frames may also be used for advertisements. For example, vehicle dealers can provide license plate frames with their company's name and phone number on them. In another example, vehicle owners can personalize license plates with expressions, phrases, contact information or other personal information for viewing.

Today, decorative license plate frames are accessible commercially and are provided by some vendors, wherein vehicle owners may choose between which decorative license plate frame they desire. This may be troublesome for vehicle owners if they want to change their decorative license plate frames, as they must change the entire license plate frame. Specifically, vehicle owners will need to purchase a new decorative license plate frame, and manually change their decorative license plate frame.

### BRIEF SUMMARY OF THE INVENTION

An embodiment of the invention provides a decorative license plate frame. The decorated license plate frame is fixed on a vehicle. The decorated license plate frame comprises a rectangular body, holding a license plate, and a first window, and a second window, wherein a first graphic card is connected to the first window and a second graphic card is connected to the second window, and the first graphic card and the second graphic card are detachable. In one embodiment, the first graphic card and the second graphic card are electronic cards with a display panel thereon for showing images which are transmitted from the vehicle owner or user.

An embodiment of the invention provides a method for ordering a customized license plate frame. The method is implemented by an order system and an electronic device of a consumer, wherein the consumer accesses, and transmits instructions or images to the order system via the electronic device. The method comprises steps of: selecting a material of the customized license plate frame; selecting a type of electronic graphic card; when the consumer selects the type of electronic graphic card, selecting electronic components and corresponding positions for disposing the electronic components on the graphic cards; checking whether a configuration of the electronic components may generate errors; if the configuration of the electronic components does not generate errors, generating a preview image of the electronic graphic card; if the configuration of the electronic components does generate errors, generating an alarm message.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic diagram of a license plate frame according to an embodiment of the invention.

FIG. 2 is a schematic diagram of an embodiment of a graphic card according to the invention.

FIG. 3 is a functional block diagram of another embodiment of a graphic card according to the invention.

FIG. 4 is a functional block diagram of an embodiment of a system of a graphic card and a license plate frame according to the invention.

FIG. 5 is an embodiment of a system of a graphic card and a license plate frame according to the invention.

FIG. 6A is a rear view of a graphic card according to an embodiment of the invention.

FIG. 6B is a schematic diagram of the graphic card 61 according to an embodiment of the invention.

FIG. 7 is a schematic diagram of a graphic card according to another embodiment of the invention.

FIG. 8A is a schematic diagram of a user interface for ordering a customized license plate frame according to an embodiment of the invention.

FIG. 8B is a schematic diagram of a user interface for ordering a customized license plate frame according to another embodiment of the invention.

FIG. 8C is a schematic diagram of a user interface for ordering a customized license plate frame according to another embodiment of the invention.

FIG. 9 is a flowchart of a customized license plate frame order procedure according to an embodiment of the invention.

FIGS. 10A and 10B show a schematic diagram of a license plate frame customized system according to an embodiment of the invention.

FIGS. 11A, 11B and 11C show a schematic diagram of a license plate frame customized system according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

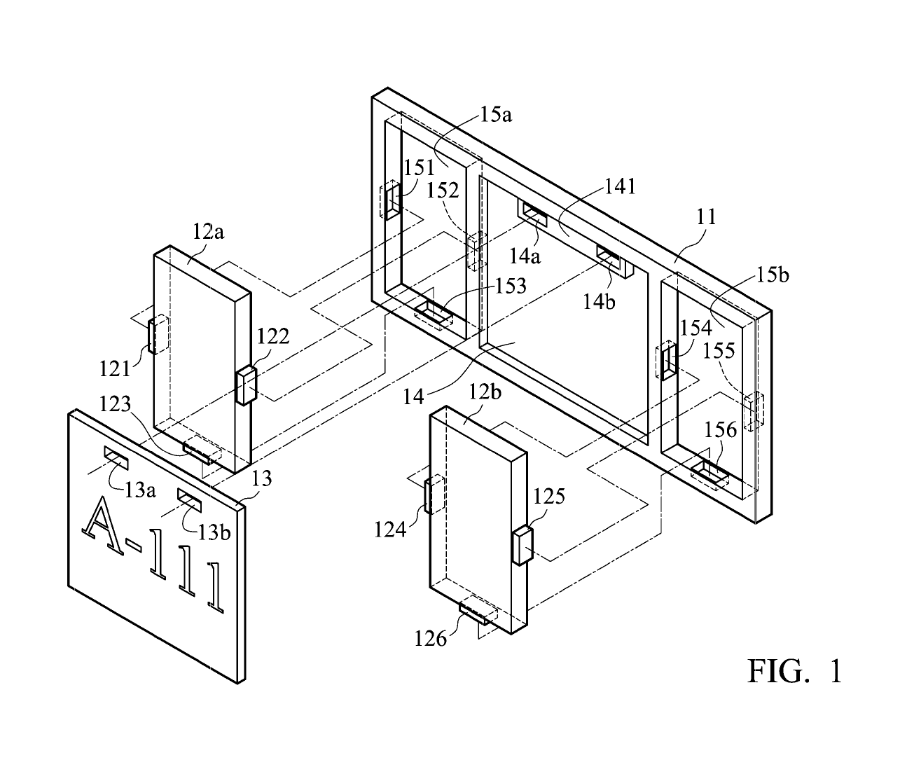

FIG. 1 is a schematic diagram of a license plate frame according to an embodiment of the invention. The license plate frame 11 comprises a rectangular body 14 for holding a license plate 13, a first window 15a for attaching a first graphic card 12a thereto, and a second window 15b for attaching a second graphic card 12b thereto. The license plate 13 comprises a first hollow 13a and a second hollow 13b for fastening the license plate 13 to the vehicle by screws. A third hollow 14a and a fourth hollow 14b on the rib 141 are designed according to the positions of the first hollow 13a and the second hollow 13b. In another embodiment, sizes of the third hollow 14a and the fourth hollow 14b are larger than the sizes of the first hollow 13a and the second hollow 13b.

The first graphic card 12a and the second graphic card 12b are detachable and the surface areas of the first graphic card 12a and the second graphic card 12b can be decorated. The first window 15a comprises a first socket 151 for connecting a first connector 121 of the first graphic card 12a thereto, a second socket 132 for connecting a second connector 122 thereto, and a third socket 153 for connecting a third connector 123 thereto. The second window 15b comprises a fourth socket 154 for connecting a fourth connector 124 of the second graphic card 112b thereto, a fifth socket 135 for connecting a fifth connector 125 thereto, and a sixth socket 156 for connecting a sixth connector 123 thereto.

In one embodiment, the material of the license plate frame 11 is the same as the material of the first graphic card 12a or the second graphic card 112b, but is not limited thereto. The material of the license plate frame 11 is preferred to be metal materials, such as steel, aluminum, cooper, magnesium alloy or an alloy of different materials. In another embodiment, plastic material can be applied, such as PVC, PP, PS, PC, ABS, PU, TPU, TPR and other plastic materials. The material of the graphic cards 12a and 12b may vary and the only requirement of the graphic cards 12a and 12b is the size, which must fit into the first window 15a and the second window 15b, respectively. In one embodiment, the size of the first window 15a is different from the size of the second window 15b. The graphic cards 12a and 12b can be decorated in different ways, such as by ink-printing, laser printing, laser etching, laser carving, coating, electroplating, 3D-printing and other ways.

In another embodiment, the graphic cards 12a and 12b are electronic graphic cards with a display device, such as an LCD panel or an electronic paper, or other electronic devices, such as an RFID tag, wireless/wired communication device, battery or others. When the graphic card 12a or 12b is an electronic graphic card, at least one of the connectors corresponding sockets have electric contact points.

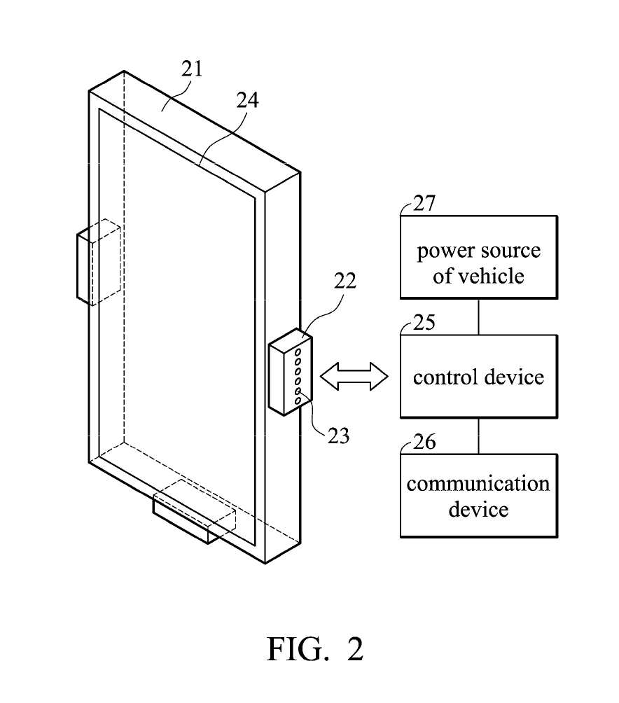

FIG. 2 is a schematic diagram of an embodiment of a graphic card according to the invention. The graphic card 21 comprises a display panel 24 and a connector 22 with contact points 23. The circuit for driving the display panel 24 is embedded in the graphic card 21 and not shown in FIG. 2. When the graphic card 21 connects to the license plate frame, such as the license plate frame 11 in FIG. 1, the contact points 23 connects to contact points in the corresponding sockets and the display panel 24 is therefore controlled by a control device 25 which is disposed on the license plate frame 11. The control device 25 is connected to a communication device 26 for communicating with a portable device of a user or a vehicle computer. The user can transmit pictures, images, texts or videos to the control device 25 via the communication device 26. The control device 25 transforms the received pictures, images, texts or videos into files that are compatible with the display panel 24, and the files are then displayed on the display panel 24.

The communication device 26 may be integrated with the control device 25. The communication device 26 supports wireless communication protocols, such as WiFi, WiMAX, Bluetooth, RFID, NFC and so on. The control device 25 connects to a power source of vehicle 27 and provides power to the communication device 26 and/or the graphic card 21. In one embodiment, the graphic card 21 comprises a battery and the control device 25 charges the battery when the graphic card 21 connects to the license plate frame. In other embodiments, the graphic card 21 is powered by its battery and when the graphic card 21 connects to the license plate frame, the graphic card 21 is powered by the control device 25.

In FIG. 2, the control device 25 transmits data to the graphic card 21 via a wired data transmission interface, however, a wireless data transmission interface between the control device 25 and the graphic card 21 may be applied. Assuming a first NFC device is embedded in the graphic card 21, and a second NFC device is embedded in the license plate frame and controlled by the control device 25, when the graphic card 21 connects to the license plate frame, the control device 25 transmits display data to the graphic card 21 via the NFC protocol. When a display controller receives the display data, the display data is then transmitted to the driving circuit for display of the data.

In the embodiment of FIG. 2, the display data is transmitted via the control device 25 to the license plate frame. However, in other embodiments, the graphic card 21 is independent from the license plate frame and can directly receive the display data from a portable device of the user.

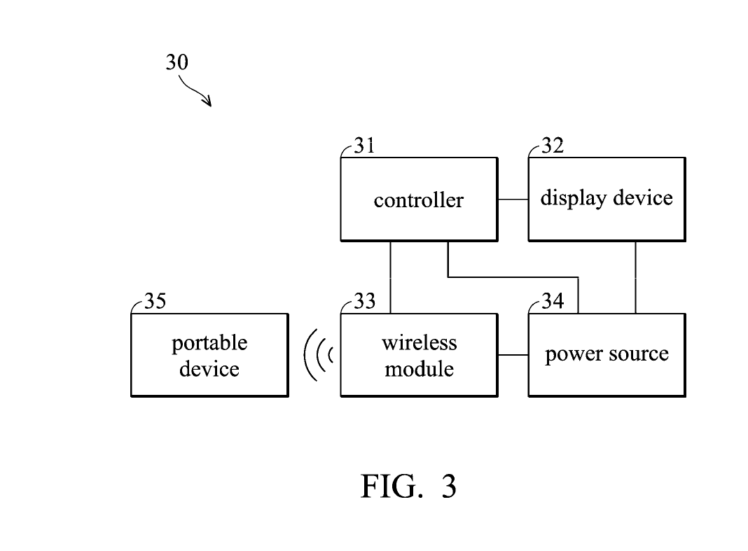

Please refer to FIG. 3. FIG. 3 is a functional block diagram of another embodiment of a graphic card according to the invention. For the shape of the graphic card, reference may be made to FIG. 2. Thus, only necessary elements are described in FIG. 3. The graphic card 30 comprises a controller 31, a display device 32, a wireless module 33, and a power source 34. The power source 34 provides power to the controller 31, the display device 32 and the wireless module 33. In this embodiment, the wireless module 33 is a WiFi module, WiMax module, a Bluetooth Module or an NFC module.

The power source 34 comprises at least one battery and may comprise a wireless charging coil. Another charging coil may be disposed on the license plate frame and when the graphic card connects to the license plate frame, the power source 34 can be charged by the charging coil of the license plate frame which is connected to another power source.

When the user wants to change the image displayed on the display device 32, the user can use a portable device 35 to transmit a first image to the wireless module 33. The wireless module 33 transmits the first image to the controller 31. In one embodiment, the first image is compatible with the display format of the display device 32. In another, the controller transforms the first image into a second image compatible with the display format of the display device 32. The display device 32 is an LCD display device, an OLED display device or an electronic paper. In another embodiment, the display device 32 is an LED matrix.

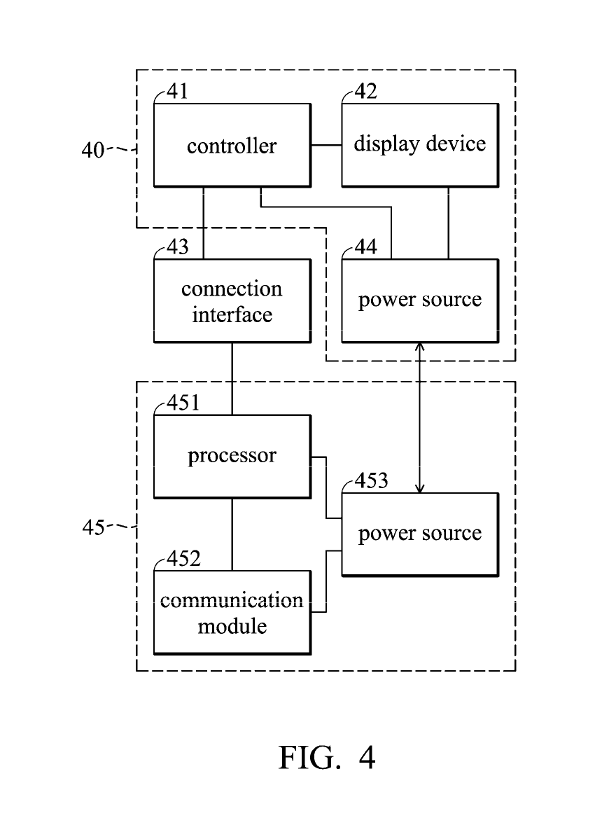

FIG. 4 is a functional block diagram of an embodiment of a system of a graphic card and a license plate frame according to the invention. The graphic card 40 connects to the license plate frame 45 via a connection cable 45. The license plate frame 45 comprises a processor 451, a communication 452 and a power source 453. The communication module 452 can receives images or texts from a portable device. The communication module 452 can be a WiFi module, a WiMax module, a Bluetooth Module, an NFC module or other wireless modules.

When the processor 452 receives a first image from the portable device via the communication module 452, the processor 452 transmits the first image to the controller 41 via the connection interface 43 which may be implemented by a cable. The controller 41 first determines whether the format of the first image is compatible with the display module 42. If the first image is compatible with the display module 42, the controller 41 directly transmits the first image to the display module 42. If the image is not compatible with the display module 42, the controller 41 transforms the first image into a second image and transmits the second image to the display module 42. Note that, in one embodiment, the display module 42 comprises a display panel, a driving circuit and a display controller. The display controller controls the driving circuit to display the received image on the display panel.

The connection interface 43 comprises a plurality of signal lines, wherein a power line is included therein. When the graphic card 40 is connected to the license plate frame 45, the power source 453 provides power to the graphic card via the power line, and in another embodiments, the power source 453 can charge the battery 44 simultaneously. The charging mechanism is not limited to a wired-charging mechanism, as a wireless charging mechanism, such as described in FIG. 3, can be applied. The power source 453 is connected to a vehicle battery and when the engine of the vehicle is turned off, the vehicle battery stops providing electric power to the power source 453. The power source 453 comprises at least one battery and when the power source 453 does not receive power from the vehicle battery, the processor 451 informs the controller 41 that the power source 453 will stop providing power after a first period of time. After the power source stops providing power to the graphic card 40, the graphic card 40 is powered by the battery 44. The display module 42 continues to display the image for a second period of time, and then is turned off for power saving.

According to the above, it is implied that a power switch mechanism is embedded in the graphic card 40. The power switch mechanism may be implemented by a circuit or the controller 41. The circuit or the controller 41 further monitors the electric capacity of the battery 44 to determine the second period of time according to the electric capacity of battery 44. Once the vehicle is turned on, the graphic card 40 is therefore activated by the power from the power source 453.

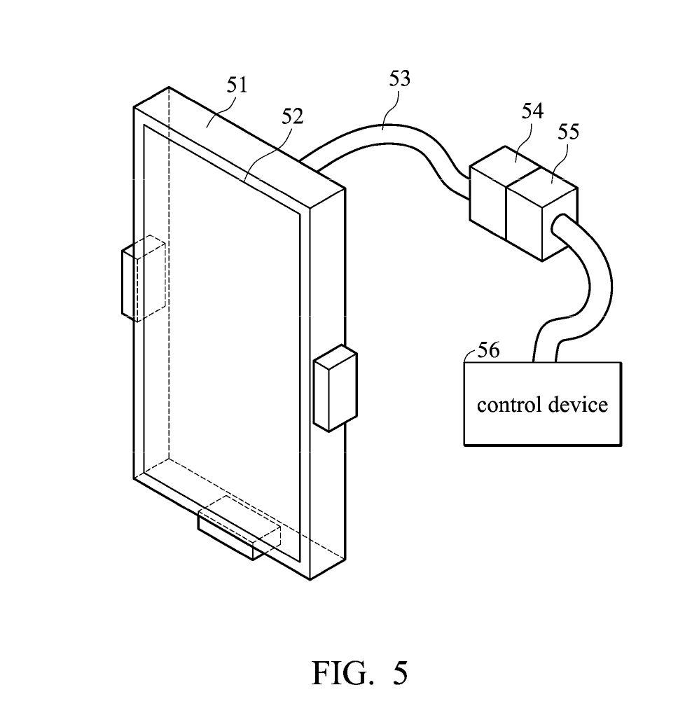

FIG. 5 is an embodiment of a system of a graphic card and a license plate frame according to the invention. The graphic card 51 comprises a display device 52, a connection cable 53 connecting to a driving circuit of the display device 52, and a first connector 54a. The control device 56 can be adhered to the back of a license plate frame via twin adhesives and connects to the graphic card 51 via a second connector 55. In one embodiment, the control device 56 is attached to the license plate frame via a specific type of alligator clip. In another embodiments, the graphic card 51 and the control device 56 can be packaged in a kit for sale. The kit is convenient for a user who does not buy the license plate frame with the control device. In another embodiments, the control device 56 is embedded in the license plate frame.

The control device 56 comprises a communication module for receiving images or texts via wireless or wired interface. When the communication module is a wireless communication module, the control device 56 can directly receive images or text from a portable device or computer, and transmits the received images or texts to the graphic card 51. In another embodiments, an application program is required for transmitting images or texts to the control device 56. When the user executes the application program in the portable device or computer, the user can select images to be displayed and the application program transforms the selected images into a display image which is compatible with the display device 52 and then transmits the display image to the control device 51.

In another embodiments, the user can type texts with/without art editing via the program, and the typed texts with/without art editing is then transformed into other display image which is transmitted to the control device 51. In other embodiments, the control device 56 comprises a connector, such as a USB connector, and the user can insert the control device 56 in a corresponding port of the computer. The user then transmits the images or texts directly to the control device 56. In other embodiments, the control device 56 comprises a socket for receiving a memory card or a flash drive. The user directly stores images or texts in a specific folder of the memory card or the flash drive. When the memory card or the flash drive is inserted in the socket, the control device 56 reads images or texts in the specific folder and transmits the images or texts to the graphic card 51 with/without format transformation.

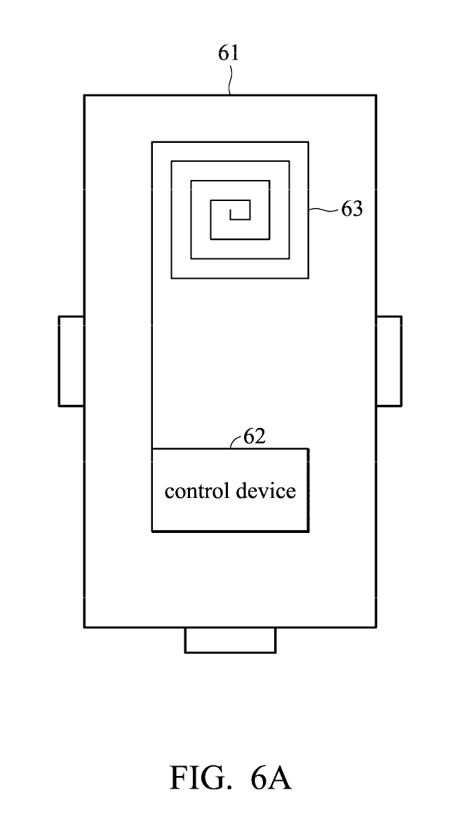

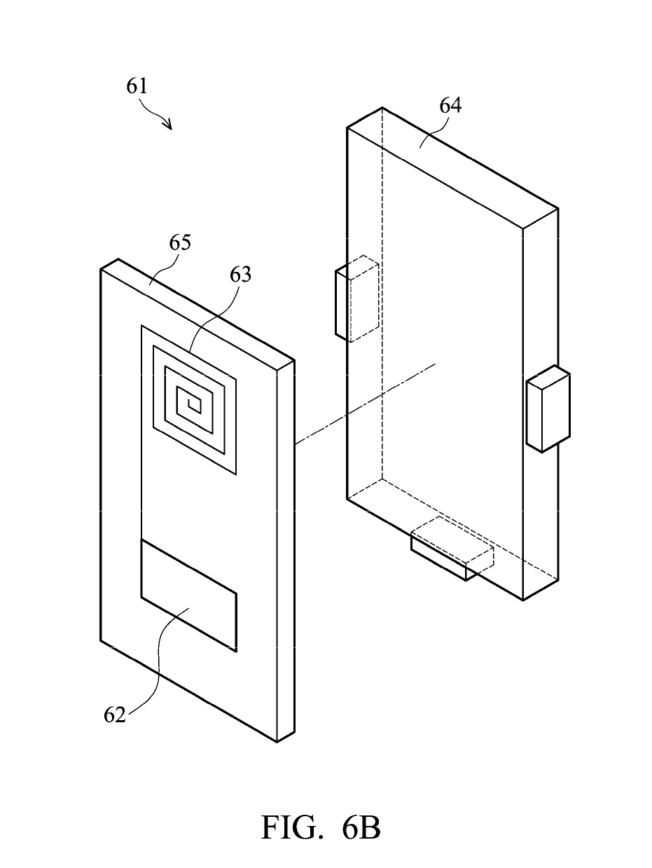

FIG. 6A is a rear view of a graphic card according to an embodiment of the invention. The graphic card 61 comprises a sensor comprising a control circuit 62 and an antenna 63. In FIG. 6A, the antenna 63 is illustrated with a spiral conductive line, but is not limited thereto. The control circuit 62 receives or senses signals via the antenna 63. The sensor may be an RFID sensor, a GPS sensor, an NFC sensor, a toll counting sensor, an RF sensor or a wireless connection sensor.

If the sensor is a GPS sensor, the control circuit 62 transmits the satellite signals to a controller to estimate a location of a vehicle with the graphic card 61. In one embodiment, the graphic card 61 displays different images according to the location of the vehicle. When the sensor is an NFC sensor and a portable device with the NFC module approaches the graphic card 61, the portable device transmits images or data to the graphic card 61 via the NFC protocol. Assuming the sensor is a toll counting sensor or an RFID sensor, the freeway toll fee can be charged via the toll counting sensor or the RFID sensor when the vehicle passes the toll station. In one embodiment, a credit card or a pre-paid card is required for paying the freeway toll fee. Therefore, a slot for receiving a credit card or a pre-paid card is mounted on the graphic card 61. The slot is connected to the control circuit 63, and when the vehicle passes the toll station, the freeway toll fee will be paid via the credit card or the pre-paid card.

FIG. 6B is a schematic diagram of the graphic card 61 according to an embodiment of the invention. The graphic card 61 comprises a main body 64 and a print circuit board 65, wherein the control circuit 62 and the antenna 63 are disposed on the circuit board. The user can customize the graphic card 61 and selects desired functional components to be disposed on the print circuit board 65. The print circuit board 65 is therefore combined with the main body 64. In other embodiments, fixing elements are required for combining the print circuit board 65 to the main body 64.

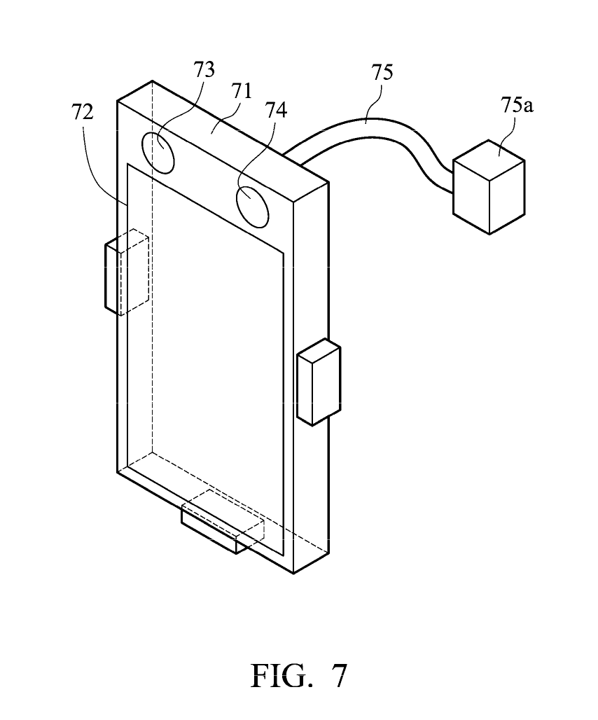

FIG. 7 is a schematic diagram of a graphic card according to another embodiment of the invention. The graphic card 71 comprises a display device, a distance detector 73 and a car recorder 74. The distance detector 73 detects a distance between the vehicle and a moving vehicle or an obstacle. When the distance detector 73 detects that the distance is less than a predetermine distance or the moving vehicle will hit the vehicle within a time period, the distance detector 73 transmits an alarm signal to the vehicle computer via the cable 75 or to a portable device via a wireless communication module (not shown in FIG. 7). The cable 75 comprises a connector 75a for connecting to a specific connector of the vehicle to transmit the signal or data to the vehicle computer. In other embodiments, the connector 75a connects to a license plate frame, such as the license plate frame 45, or a control device of a license plate frame, such as the control device 25, and the signal or data communication between the graphic card and the vehicle computer portable device of a user is implemented by the control device or the license plate frame.

The car recorder 74 continuously records videos, overwrites the previous few minutes of video data and stops recording until a crash occurs or the vehicle is turned off. The real time video can be displayed on a display device of the vehicle or portable device of a user via wired or wireless communication. The recorded data is stored in a memory card. The graphic card 71 comprises a memory card slot connecting to the card recorder 74 to store the recorded video data.

In one embodiment, the car recorder 74 works with the distance detector 73. In a normal condition, the video data is stored in a first folder of the memory card. The previous minutes of video data will be overwritten by video data recorded later. If the distance detector 73 detects the distance between the vehicle and a upcoming car from the same direction is less than a safety distance, the video data is stored in a second folder, wherein the video data stored in the second folder cannot be deleted or overwritten unless manual operation by a user. In other embodiments, the car recorder 74 comprises a control device which receives the data from the distance detector 73. The control device estimates the relative speed of the rear car, the distance to the rear car and estimates a time that the rear car may hit the vehicle. Once one of the relative speed, the distance and the time matches a predetermined condition, the control device transmits a control signal to the car recorder 74 and the recorded video data is then stored in the second folder.

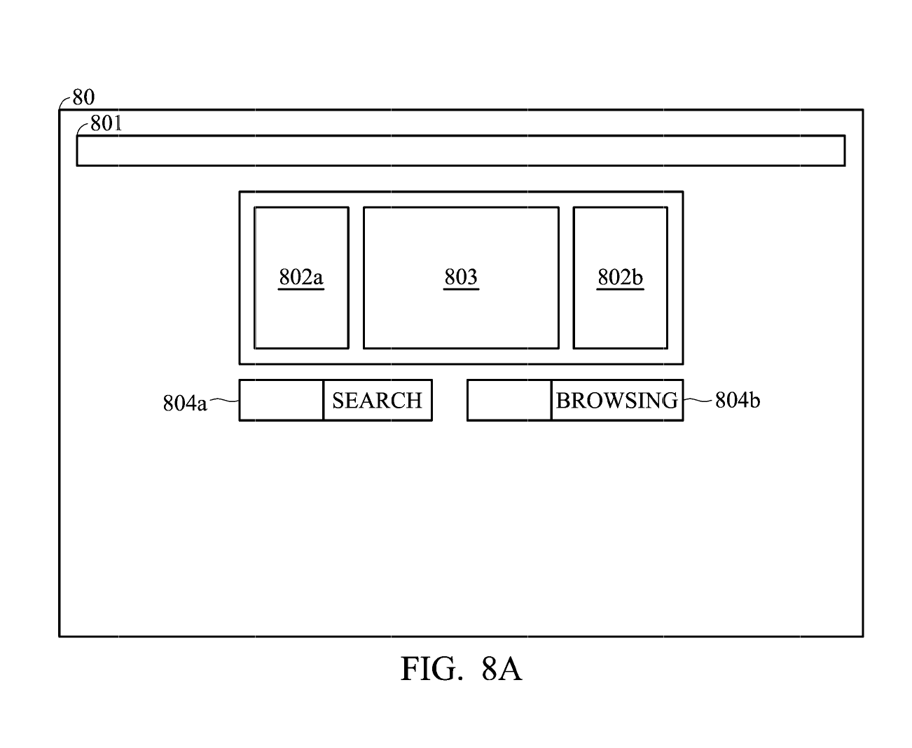

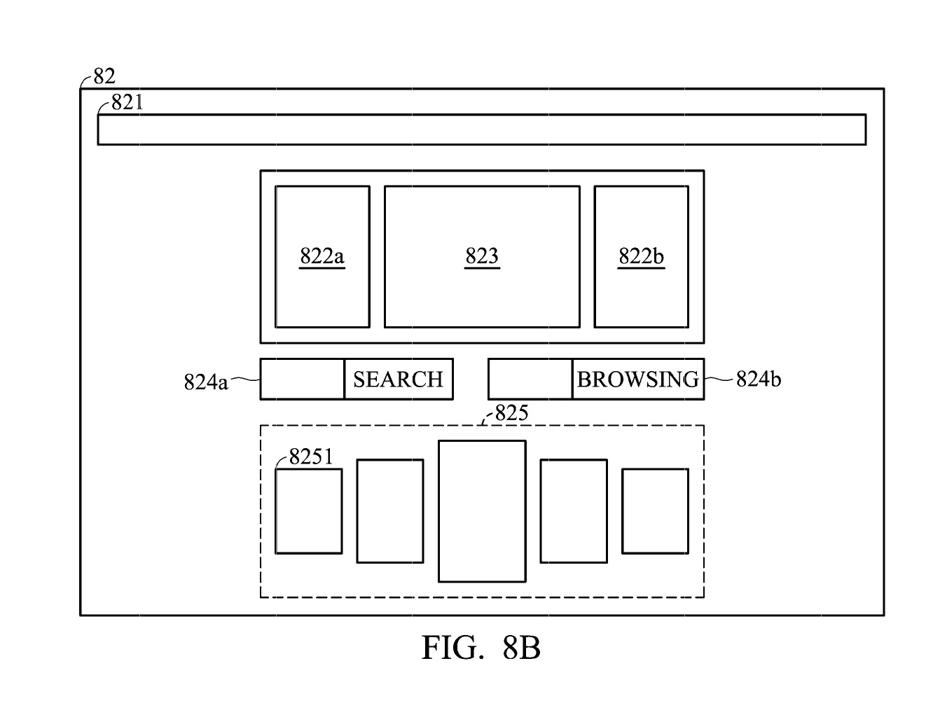

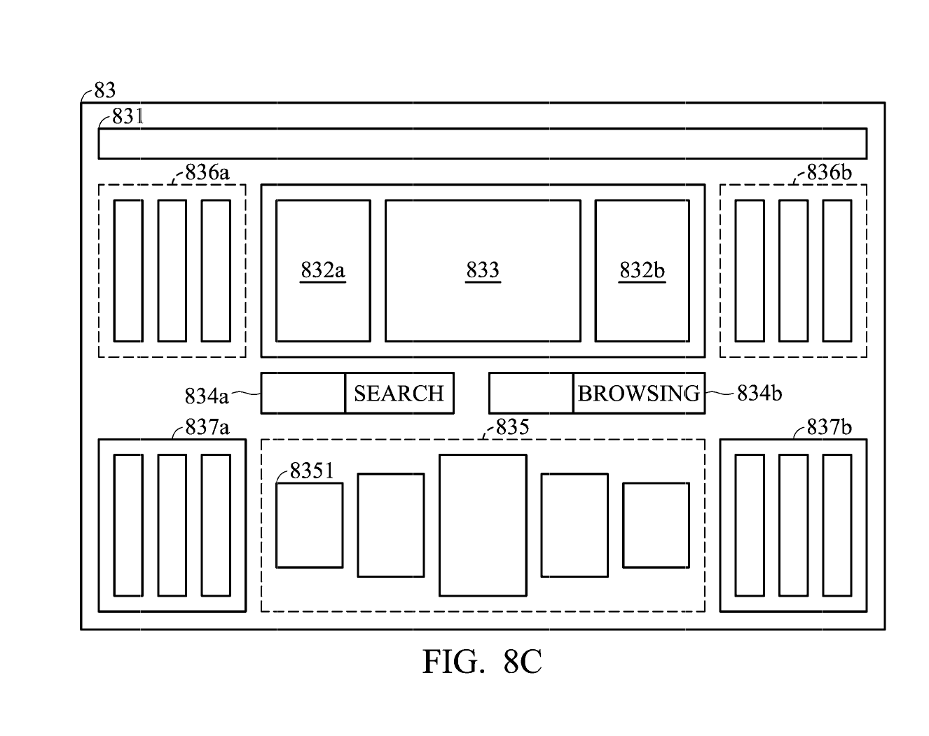

FIG. 8A is a schematic diagram of a user interface for ordering a customized license plate frame according to an embodiment of the invention. When the user enters the website of the ordering system, the main page is shown as FIG. 8A. Field 801 shows the URL of the website, and other function buttons of the browser can be also shown in the user interface. When the user clicks or selects the field 802a, the user can upload a first image to the field 802a. When the user clicks or selects the field 802b, the user can upload a second image to the field 802b. After the user types numbers on the license plate in the field 803, the user can preview the result of his customized license plate. In one embodiment, fields 802a, 802b and 803 are a sample image of a license plate frame. This means that no available fields are shown in the area of the fields 802a, 802b and 803. When the cursor moves to the area of the field 802a or 802b and a click is detected, a function menu pops up and the consumer uploads images from his computer or selects images stored in a database of a system. When the cursor moves to the area of the field 803 and a click is detected, an input field pops up and the consumer types numbers on the license plate in the popped-up filed.

When the user wants to search images on the Internet, the user can type key words in the field 804a. When the user wants to search images in the database of the ordering system, the user can type key words in the field 804b. It is noted that the user can determine whether to make the images accessible to the public. If the user makes the images accessible to the public, other users can search the images in the database. According to the described paragraph, the ordering system provides two search mechanisms for users to search for through a local database or through the Internet.

FIG. 8B is a schematic diagram of a user interface for ordering a customized license plate frame according to another embodiment of the invention. When the user enters the website of the ordering system, the main page is shown as FIG. 8B. Field 821 shows the URL of the website, and other function buttons of the browser can be also shown in the user interface. When the user clicks or selects the field 822a, the user can upload a first image to the field 822a. When the user clicks or selects the field 822b, the user can upload a second image to the field 822b. After the user types numbers on the license plate in the field 823, the user can preview the result of his customized license plate. In one embodiment, fields 822a, 822b and 823 are a sample image of a license plate frame. This means that no available fields are shown in the area of the fields 822a, 822b and 823. When the cursor moves to the area of the field 822a or 822b and a click is detected, a function menu pops up and the consumer uploads images from his computer or selects images stored in a database of a system. When the cursor moves to the area of the field 823 and a click is detected, an input field pops up and the consumer types numbers on the license plate in the popped-up field.

When the user wants to search images on the Internet, the user can type key words in the field 824a. When the user wants to search images in the database of the ordering system, the user can type key words in the field 824b. It is noted that the user can determine whether to make the images accessible to the public. If the user makes the images accessible to the public, other users can search for the images in the database. According to the described paragraph, the ordering system provides two search mechanisms for users to search through a local database or through the Internet.

The field 825 shows examples of electronic graphic cards or a candidate list of electronic graphic cards according to user interactions or system default settings. In one embodiment, the order system provides a business mode for graphic card developers and consumers. When the consumers pay for the graphic cards or images are provided by developers, a predetermined percentage of the money is returned to the company owner and the remaining goes to the developer. Thus, the developer can pay for advertising their graphic card in the field 825 to attract consumers. In other embodiments, the field 825 shows different textures of materials, such as plastic, wood, metal and other material textures. The user can preview the image on different textures in the field 822a and 822b to determine which texture is desired.

FIG. 8C is a schematic diagram of a user interface for ordering a customized license plate frame according to another embodiment of the invention. When the user enters the website of the ordering system, the main page is as shown as FIG. 8C. Field 831 shows the URL of the website, and other function buttons of the browser can be also shown in the user interface. When the user clicks or selects the field 832a, the user can upload a first image to the field 832a. When the user clicks or selects the field 822b, the user can upload a second image to the field 832b. After the user types numbers on the license plate in the field 833, the user can preview the result of his customized license plate. In one embodiment, fields 832a, 832b and 833 are a sample image of a license plate frame. This means that no available fields are shown in the area of the fields 832a, 832b and 833. When the cursor moves to the area of the field 832a or 832b and a click is detected, a function menu pops up and the consumer uploads images from his computer or selects images stored in a database of a system. When the cursor moves to the area of the field 833 and a click is detected, an input field pops up and the consumer types numbers on the license plate in the popped-up field.

When the user wants to search images on the Internet, the user can type key words in the field 834a. When the user wants to search images in the database of the ordering system, the user can type key words in the field 834b. It is noted that the user can determine whether to make the images accessible to the public. If the user makes the images accessible to the public, other users can search for the images in the database. According to the described paragraph, the ordering system provides two search mechanisms for users to search through a local database or through the Internet.

The field 835 shows examples of electronic graphic cards or a candidate list of electronic graphic card according to user interactions or system default settings. In other embodiments, the field 835 shows different textures of materials, such as plastic, wood, metal and other material textures. The user can preview the images of different textures in the field 832a and 832b to determine which texture is desired. Fields 836a and 836b shows previous selected graphic cards. The consumer can directly select graphic cards in the field 836a and 836b.

In one embodiment, the order system provides a business mode for graphic card developers and consumers. When the consumers pays for the graphic cards or images provided by developers, a predetermined percentage of the money is returned to the company owner and the remaining goes to the developer. Thus, the developer can pay for advertising their graphic card in the fields 837a and 837b to attract consumer attention. In other embodiments, the field 837a shows the Top 3 or Top 10 popular graphic cards.

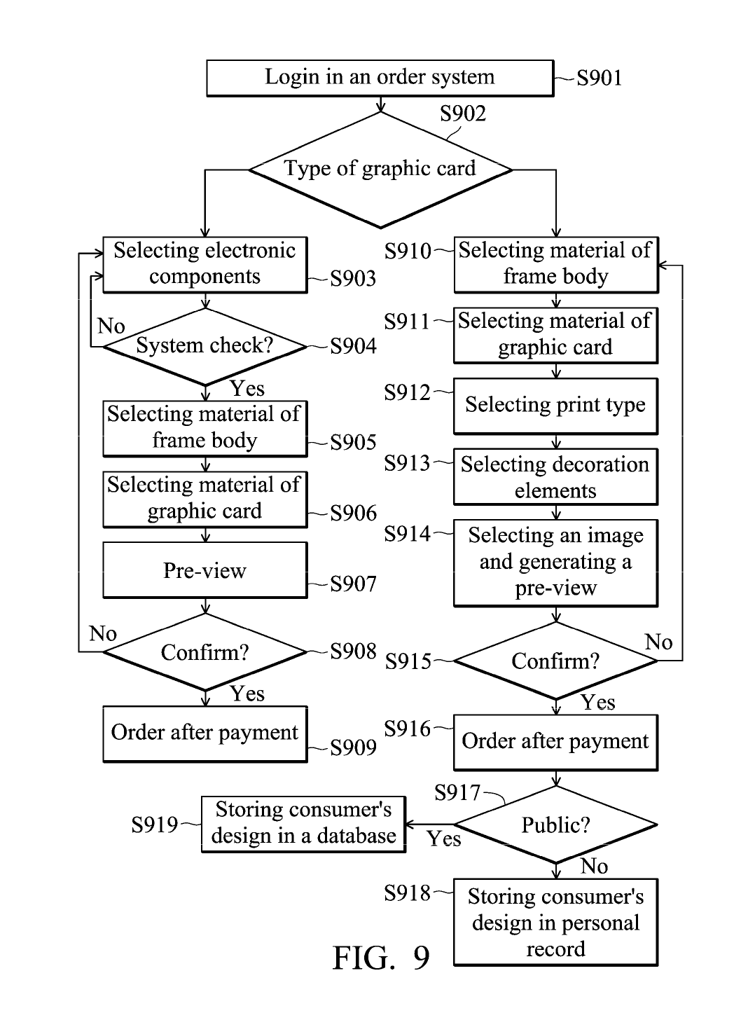

FIG. 9 is a flowchart of a customized license plate frame order procedure according to an embodiment of the invention. In step S901, the consumer logs into the order system to customize his license plate frame. The order system is a software program executed by a computer or a server. The consumer uses his electronic device, such as a computer or a portable device, to access the order system and performs actions via input means of the electronic device. In step S902, the consumer selects a type of electronic graphic card. In this embodiment, the type of the graphic card comprises an electronic type and a traditional type. If the consumer selects the type of electronic type, the procedure goes to step 903. If the consumer selects the type of traditional type, the procedure goes to step S910. In this embodiment, the traditional type graphic card and the electronic type graphic card are detachable.

In step S903, the consumer selects electronic components, such as a display device, camera, wireless module, Bluetooth module, RF module, GPS sensor, NFC module, RFID, distance detector and others. It is noted that the electronic graphic card comprises sockets for receiving the electronic components. When the consumer selects the type of desired electronic components, the procedure goes to step 904. The ordering system checks the choices of the consumer and determines whether all of the selected electronic components can be assembled in the graphic card. For example, to avoid wireless interference, the ordering system checks the positions of the selected electronic components to determine whether wireless signal interference would occur. In another example, assuming only one first socket is provided on the graphic card and the consumer selects two modules suited for the first socket, the ordering system shows an error message and the procedure returns to step S903.

When a configuration of the selected components of the user pass the check procedure, such as the step S904, the procedures goes to step S905. In step S905, the consumer selects the material of the license plate frame. The material may be a plastic material, a metal material, an acrylics material, or others. In step S906, the consumer selects a material of the graphic card. In one embodiment, the graphic card comprises a main body and a print circuit board, such as that shown in FIG. 6B, and the consumer selects the type of material of the main body.

In step S907, the ordering system generates a 3D preview for the consumer. The consumer rotates the 3D preview to see the graphic card in different angles. In step S908, the order system determines whether the consumer has confirmed or satisfies the design. If yes, the procedure goes to step S909, and the order system directs the consumer to a payment mechanism, such as a credit card payment mechanism. After the consumer finishes the payment procedure and the order system receives a confirmation message from the payment mechanism, the order is transmitted to the manufacturer for production. If the consumer does not confirm or satisfy the design, the procedure returns to step S903, and the above steps are repeated again.

If the consumer selects the traditional type in step S902, step S910 is executed. In step S910, the consumer selects the type of material of the license plate frame. The material of the license plate frame may be one of steel, aluminum, cooper, magnesium alloy, an alloy of different materials, PVC, PP, PS, PC, ABS, PU, TPU, TPR and other types of materials. In step S911, the consumer selects the type of material of the graphic card. The material of the graphic card may be one of steel, aluminum, cooper, magnesium alloy, an alloy of different materials, wood, PVC, PP, PS, PC, ABS, PU, TPU, TPR and other types of materials. In step S912, the consumer selects a print type. It is noted that the print type may be limited by the material of the graphic card. For example, ink-printing is not suited for the metal material, and the ordering system will filter the unsuitable print types out to prevent the consumer from selecting the unsuitable print type. In step S913, the consumer can select decorative elements, such as jewelry decorations, leather decorations, ceramic decorations, wood decorations or other decorations, to be decorated on the graphic card or license plate frame. In this embodiment, the order of the steps S910 to S913 is only for illustration, and does not limit the invention. The only requirement of the steps S910 to S913 is to be executed before step S914.

In step S914, the consumer uploads images or selects image from a database of the order system and the order system generates a preview of the design of the consumer. In step S915, the order system determines whether the consumer has confirmed or satisfies the design. If yes, the procedure goes to step S916, and the order system directs the consumer to a payment mechanism, such as a credit card payment mechanism. After the consumer finishes the payment procedure and the order system receives a confirmation message from the payment mechanism, the order is transmitted to the manufacturer for production. If the consumer does not confirm or satisfy the design, the procedure returns to step S910, and the above steps are repeated again.

In step S917, the order system asks the consumer to make the design public or not. If the consumer agrees to make the design public, step S919 is executed. In step S919, the design of the consumer is stored in a database and other users can search for the design of the consumer. If the consumer does not agree to make the design public, step S918 is executed and the design of the consumer is stored in a personal record or personal database.

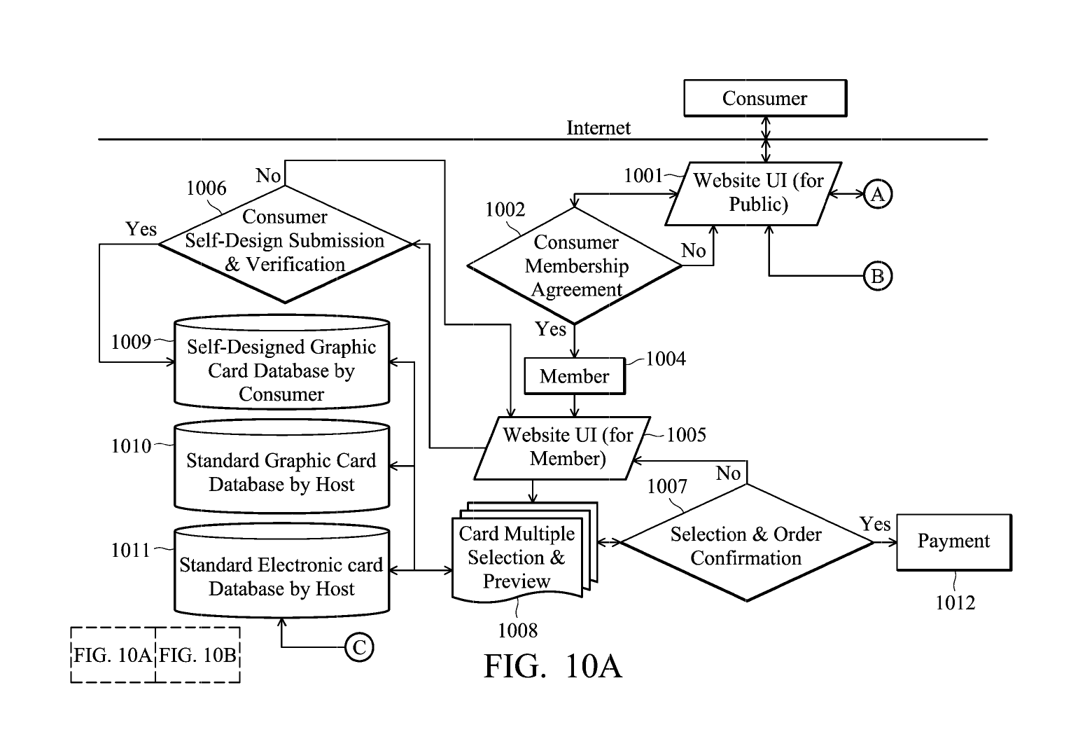

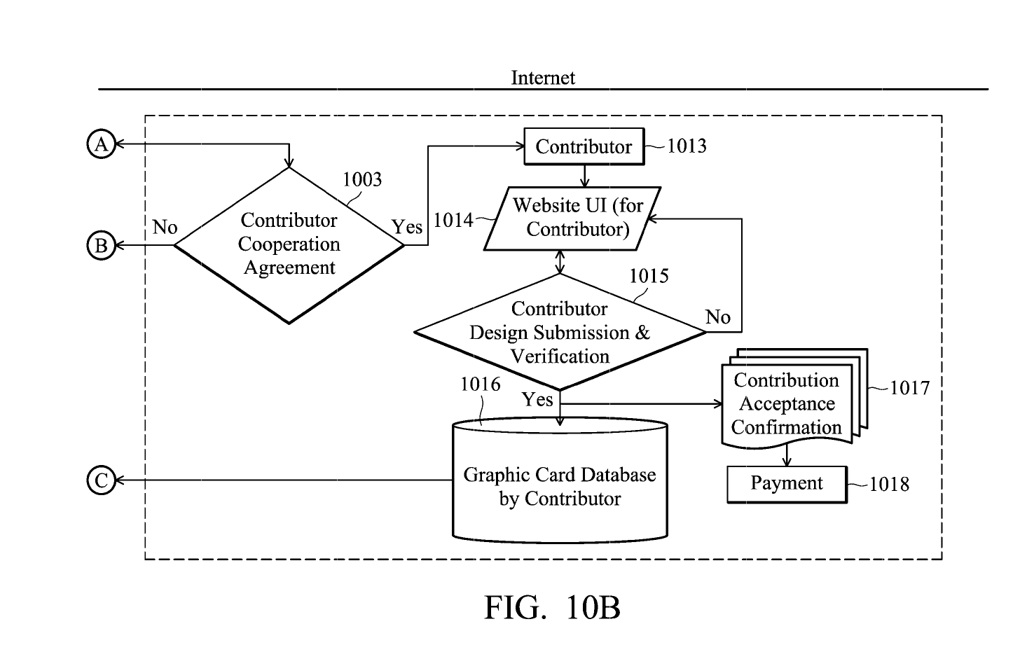

FIGS. 10A and 10B show a schematic diagram of a license plate frame customized system according to an embodiment of the invention. The customized system is operated by a computer or a server that can be accessed via internet. The blocks shown in FIG. 10 may be a step executed by the customized system or an electronic device of the customized system. The connection between blocks can be modified by skilled person in the art according to different demands.

The block 1001 provides a public website UI (user interface) to the viewers. Before the viewers become a member of the customized system or a contributor of the customized system, only public website UI is provided. The viewers can browse limited information of customized system, such as standard license plate frames, demo license plate frames or introduction of the customized system.

When the views decide to be a member or a contributor of the customized system, blocks 1002 and 1003 provides a consumer membership agreement or a contributor cooperation agreement to the consumer. The blocks 1002 and 1003 may be implemented or executed by a member management module. The member management module may be hardware implemented or a program executed by a processor of the computer. After the consumer accepts the consumer membership agreement, block 1004 grants a member right to the consumer's account. The block 1004 may be a part of the member management module and provides different membership to the consumer according to consumer's selection. In one embodiment, the membership comprises free membership and paid membership.

In block 1005, the customized system provides website UI according to consumer's membership. It is noted that the blocks 1001, 1005 and 1014 may be implemented by a UI management module. When the consumer logs in the customized system, the UI management module acquires corresponding membership or access right from the member management module and shows corresponding UI to the consumer.

When the consumer logs in the customized system, the consumer can uploads his frame plate design, and block 1006 verifies the uploaded frame plate design. The block 1006 may be a verification module to determine whether the frame plate design contains obscene images or prejudice words against others. If the consumer's design does not pass the verification procedure, the block 1006 shows error message on the website UI to inform the consumer. If the consumer's design passes the verification procedure, the consumer's design is stored in the block 1009 and shows messages on the website UI to inform the consumer that his design is accepted and stored in the system. The block 1009 is a database designated to the consumer. The database is a part of a storage device, such as a hard disc, and is modified only by the consumer or the administrator of the system. In one embodiment, the memory capacity of the database owned by the paid member is larger than that owned by the free member.

The block 1010 is a standard graphic card database provided by the customized system. The block 1011 is a standard electronic card database provided by the customized system. When the consumer designs his own plate frame in block 1008, the consumer can users the data from the block 1010 and 1011. The operation of the block 1008 can be referred in FIG. 9 and corresponding description and not discussed here for briefly. The block 1008 can be implemented by a plate frame customized module which is operated by the customized system. In one embodiment, the plate frame customized module is independent from the customized system to reduce the load of the customized system.

The block 1007 is an order confirmation module and when the consumer decides to produce his plate frame, block 1007 executes some confirmation procedure, such as the steps S908 and S915 in FIG. 9. The block 1012 is a payment module to deal with the incurred payment. In one embodiment, the payment module is an external module and the customized system directs the user to pay the payment in other website. It is noted that the block 1012 only deals with the payment between the consumer and the customized module.

After the consumer accepts the contributor cooperation agreement, block 1013 grants a contributor right to the consumer's account. The block 1013 may be a part of the member management module. In one embodiment, the blocks 1004 and 1013 are implemented by the member management module.

In block 1015, the customized system provides website UI according to contributor's membership. It is noted that the blocks 1001, 1005 and 1015 may be implemented by a UI management module. When the consumer logs in the customized system, the UI management module acquires corresponding membership or access right from the member management module and shows corresponding UI to the contributor.

In block 1015, the contributor submits his frame plate design, and block 1015 verifies the uploaded frame plate design. The block 1015 may be the same verification module of the block 1006 to determine whether the frame plate design contains obscene images or prejudice words against others. If the contributor's design does not pass the verification procedure, the block 1015 shows error message on the website UI to inform the contributor. If the contributor's design passes the verification procedure, the contributor's design is stored in the block 1016 and shows messages on the website UI to inform the consumer that his design is accepted and stored in the system. The block 1016 is a database designated to the contributor. The database is a part of a storage device, such as a hard disc, and is modified only by the contributor or the administrator of the system.

The block 1017 then shows contribution acceptance confirmation on the website UI and directs the contributor to block 1018. The block 1018 is a payment module to deal with the contributor's design payment. In one embodiment, the payment module is an external module and the customized system directs the user to receive the payment in other website. It is noted that the block 1018 only deals with the payment between the contributor and the customized module.

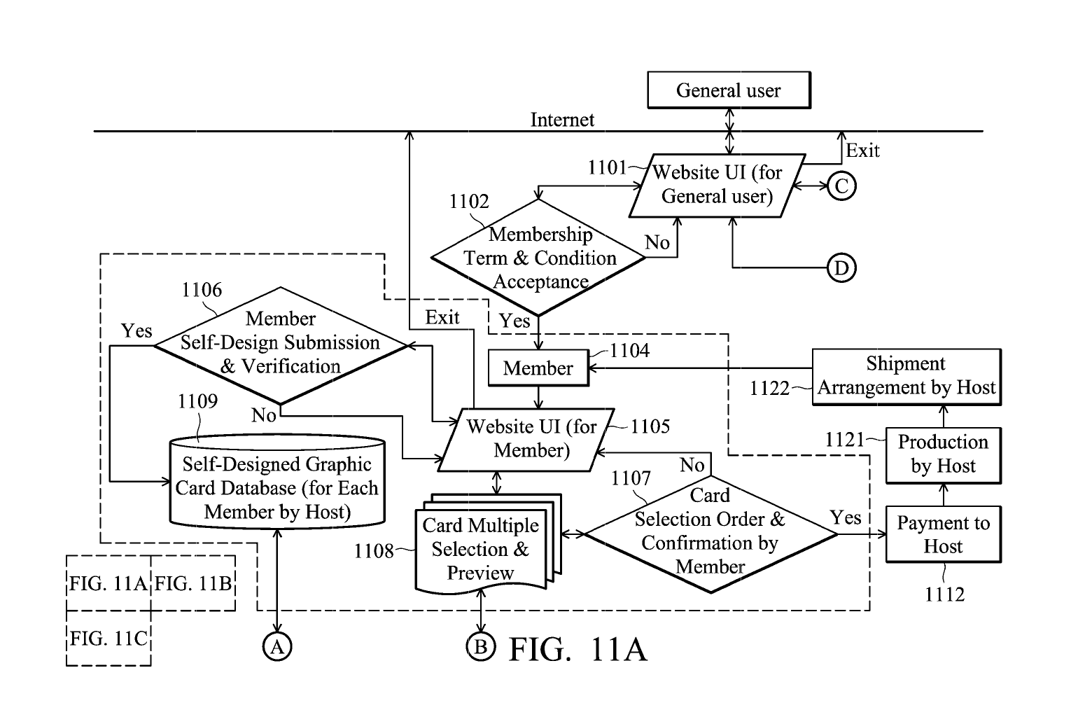

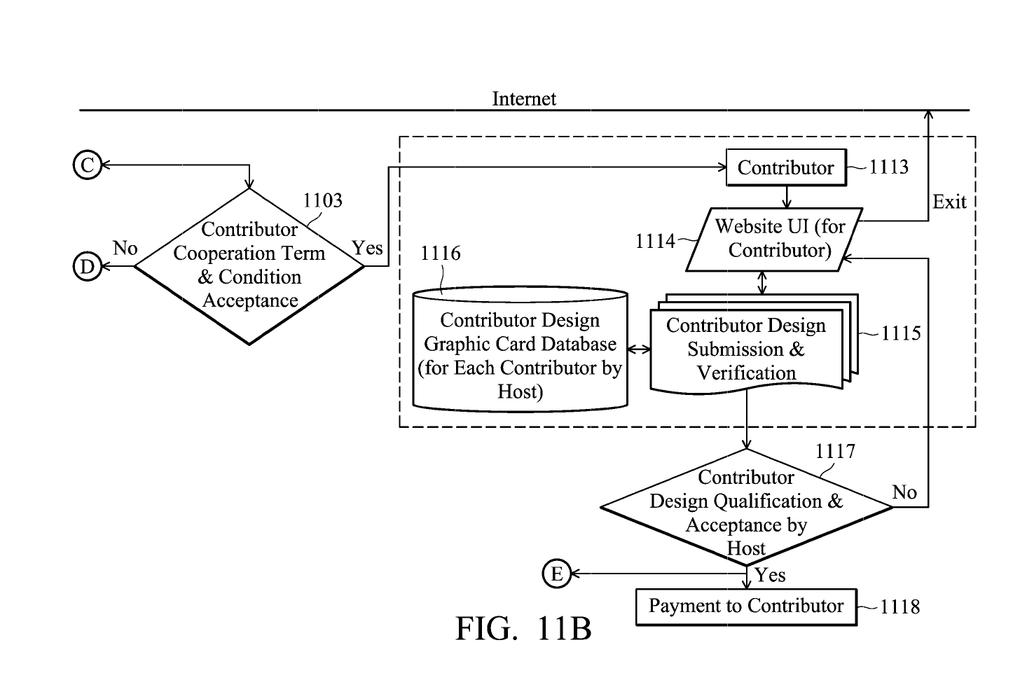

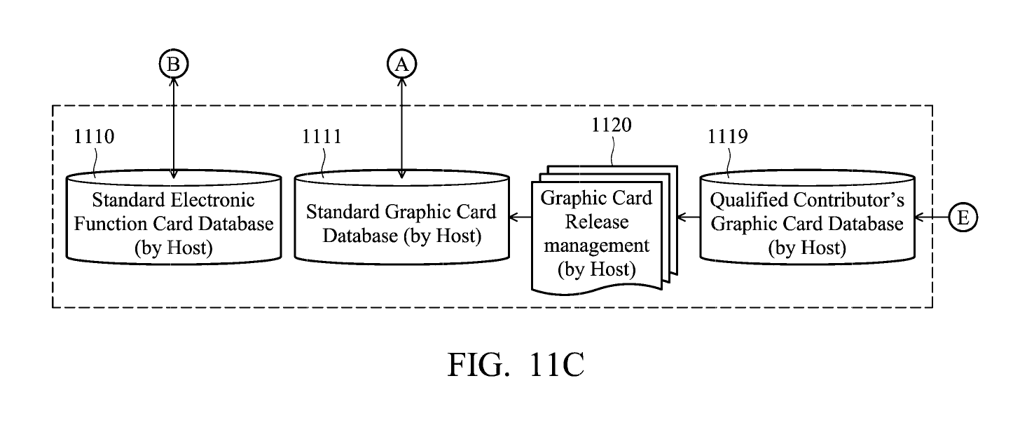

FIGS. 11A, 11B and 11C show a schematic diagram of a license plate frame customized system according to another embodiment of the invention. The customized system is operated by a computer or a server that can be accessed via internet. The blocks shown in FIG. 11 may be a step executed by the customized system or an electronic device of the customized system. The connection between blocks can be modified by skilled person in the art according to different demands. The connection between blocks represents the data transmission between blocks or indicates a next step from the current block.

The block 1101 provides a general website UI (user interface) to the general viewers. Before the viewers become a member of the customized system or a contributor of the customized system, only general website UI is provided. The viewers can browse limited information of customized system, such as standard license plate frames, demo license plate frames or introduction of the customized system.

When the views decide to be a member or a contributor of the customized system, blocks 1102 and 1103 provides a consumer membership agreement or a contributor cooperation agreement to the consumer. The blocks 1102 and 1103 may be implemented or executed by a member management module. The member management module may be hardware implemented or a program executed by a processor of the computer. After the consumer accepts the consumer membership agreement, block 1104 grants a member right to the consumer's account. The block 1104 may be a part of the member management module and provides different membership to the consumer according to consumer's selection. In one embodiment, the membership comprises free membership and paid membership.

In block 1105, the customized system provides website UI according to consumer's membership. It is noted that the blocks 1101, 1105 and 1114 may be implemented by a UI management module. When the consumer logs in the customized system, the UI management module acquires corresponding membership or access right from the member management module and shows corresponding UI to the consumer.

When the consumer logs in the customized system, the consumer can uploads his frame plate design, and block 1106 verifies the uploaded frame plate design. The block 1106 may be a verification module to determine whether the frame plate design contains obscene images or prejudice words against others. If the consumer's design does not pass the verification procedure, the block 1106 shows error message on the website UI to inform the consumer. If the consumer's design passes the verification procedure, the consumer's design is stored in the block 1109 and shows messages on the website UI to inform the consumer that his design is accepted and stored in the system. The block 1109 is a database designated to the consumer. The database is a part of a storage device, such as a hard disc, and is modified only by the consumer or the administrator of the system. In one embodiment, the memory capacity of the database owned by the paid member is larger than that owned by the free member. In one embodiment, the consumer can pick some plate frame designs from the standard graphic card database 1111 and stored the selected plate frame design in the block 1109. In other embodiment, the consumer can submit his design to the customized system for public or free use. The donated designs are then stored in the standard graphic card database 1111.

The block 1111 is a standard graphic card database provided by the customized system. The block 1110 is a standard electronic card database provided by the customized system. When the consumer designs his own plate frame in block 1108, the consumer can users the data from the block 1110 and 1111. The operation of the block 1108 can be referred in FIG. 9 and corresponding description and not discussed here for briefly. The block 1108 can be implemented by a plate frame customized module which is operated by the customized system. In one embodiment, the plate frame customized module is independent from the customized system to reduce the load of the customized system.

The block 1107 is an order confirmation module and when the consumer decides to produce his plate frame, block 1107 executes some confirmation procedure, such as the steps S908 and S915 in FIG. 9, and estimates the production fee. The block 1112 is a payment module to deal with the incurred payment. In one embodiment, the payment module is an external module and the customized system directs the user to pay the payment in other website. It is noted that the block 1112 only deals with the payment between the consumer and the customized module.

After the consumer pays the payment, the customized system prepares to produce the consumer's plate frame in block 1121 and arranges the shipment affair in block 1122. The block 1121 may be implemented between the customized system and the manufacture.

After the consumer accepts the contributor cooperation agreement, block 1113 grants a contributor right to the consumer's account. The block 1113 may be a part of the member management module. In one embodiment, the blocks 1104 and 1113 are implemented by the member management module.

In block 1115, the customized system provides website UI according to contributor's membership. It is noted that the blocks 1101, 1105 and 1115 may be implemented by a UI management module. When the consumer logs in the customized system, the UI management module acquires corresponding membership or access right from the member management module and shows corresponding UI to the contributor.

In block 1115, the contributor submits his frame plate design and stores the design in the block 1016. The block 1016 stores the contributor's design and cannot be accessed by public or other members of the customized system. When the contributor decides to public his design, block 1117 verifies the submitted frame plate design. The block 1117 may be the same verification module of the block 1106 to determine whether the frame plate design contains obscene images or prejudice words against others.

If the contributor's design does not pass the verification procedure, the block 1115 shows error message on the website UI to inform the contributor. If the contributor's design passes the verification procedure, the contributor's design is stored in the block 1119 and shows messages on the website UI to inform the consumer that his design is accepted and stored in the system. The block 1119 is a database designated to the contributor to stored qualified contributor's frame plate design. The database is a part of a storage device, such as a hard disc, and is modified only by the contributor or the administrator of the system.

After the contributor's design is accepted and public by the customized system, the customized system directs the contributor to block 1118. The block 1118 is a payment module to deal with the contributor's design payment. In one embodiment, the payment module is an external module and the customized system directs the user to receive the payment in other website. It is noted that the block 1118 only deals with the payment between the contributor and the customized module.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A license plate frame to be fixed on a vehicle, comprising:
a rectangular body, holding a license plate;
a first window and a second window;
a first graphic card, connecting to the first window; and
a second graphic card, connecting to the second window,
wherein the first graphic card and the second graphic card are detachable.

2. The license plate frame as claimed in claim 1, wherein the first graphic card is an electronic graphic card.

3. The license plate frame as claimed in claim 2, wherein the first graphic card comprises a main body and a print circuit board.

4. The license plate frame as claimed in claim 3, wherein the first graphic card further comprises a display device to display an image.

5. The license plate frame as claimed in claim 4, wherein the first graphic card further comprises a connection cable, connecting to a control device of the license plate frame, wherein the first image is received from the control device.

6. The license plate frame as claimed in claim 5, wherein the control device is connected to a communication module to receive data from an electronic device.

7. The license plate frame as claimed in claim 2, wherein the first graphic card comprises a sensor and an antenna circuit disposed on the print circuit board.

8. The license plate frame as claimed in claim 7, wherein the sensor is an RFID sensor, a GPS sensor, an NFC sensor, a toll counting sensor, an RF sensor or a wireless connection sensor

9. The license plate frame as claimed in claim 1, wherein the first graphic card further comprises:
a communication module, receiving an image; and
a display device, displaying the image.

10. The license plate frame as claimed in claim 9, wherein the communication module is a WiFi module, WiMax module, a Bluetooth Module or an NFC module.

11. The license plate frame as claimed in claim 1, wherein the first graphic card further comprises a car recorder for video recordings.

12-20. (canceled)
